(19) United States
(12) Patent Application Publication
(10) Pub. No.: US 2006/0127067 A1
(43) Pub. Date: Jun. 15, 2006

(54) Fast heating and cooling wafer handling assembly and method of manufacturing thereof

(75) Inventors: Eric Wintenberger, Beachwood, OH (US); Sridhar R. Prasad, Bangalore (IN); John Mariner, Avon Lake, OH (US); Zhong-Hao Lu, Chagrin Falls, OH (US)

Correspondence Address: GEAM - QUARTZ;IP LEGAL, ONE PLASTICS AVENUE, PITTSFIELD, MA, 01201-3697, US

(73) Assignee: General Electric Company

(21) Appl. No.: 11/269,346

(22) Filed: Nov. 8, 2005

Related U.S. Application Data
(60) Provisional application No. 60/635,636, filed on Dec. 13, 2004.
(60) Provisional application No. 60/650,392, filed on Feb. 4, 2005.

(51) Int. Cl. F27B 5/14

(52) U.S. Cl. 392/416; 219/390

(57) ABSTRACT

A thermal control device for wafer processing which comprises a) a platform for placement of an object of various sizes to be heated, b) at least a shaft extending substantially transverse to the platform; and c) a plurality of resistance heating elements patterned in a plurality of circuits defining at least one zone for independent controlled heating of objects of varying sizes on the platform.

### CROSS-REFERENCE TO RELATED APPLICATIONS

This application claims the benefits of U.S. Provisional Patent Application Ser. No. 60/635636 filed Dec. 13, 2004, and U.S. Provisional Patent Application Ser. No. 60/650392 filed Feb. 4, 2005, which patent applications are fully incorporated herein by reference.

### FIELD OF THE INVENTION

The invention relates generally to a wafer-handling assembly for use in the manufacture of semiconductors.

### BACKGROUND OF THE INVENTION

Wafer handling assemblies are used in a number of system applications such as molecular beam epitaxy, space experiments, and substrate heaters for electron microscopy and in the growth of superconducting films, etc. A wafer-processing chamber or assembly is a device that heats objects, such as semiconductor wafers. In semiconductor wafer processing, fast heating and cooling cycles are often needed in steps such as annealing or degassing. These steps usually consist of any number of fast heating processes, sometimes requiring immediate cooling, and sometimes followed by a constant temperature process requiring accurate temperature control, and then a fast cooling process.

The energy input into the wafer in the overall time-temperature cycle is often referred to as the thermal budget. The thermal budget is limited by adverse effects on the wafer; too hot, too long, or any excursion from a prescribed time-temperature recipe can cause defects in the wafer. These steps can be done in a tube furnace, where wafers are processed in a batch mode. However, the need to wait for conditions in the furnace to reach steady state for uniform results typically requires long processing times, which may violate limitations imposed by the thermal budget or the process recipe.

US Patent Application No. 2004/0035847 disclosed an alternative to batch furnaces with an apparatus for fast heating and cooling with a device for actively cooling the wafers after they have been heated. For rapid heating, the device employs high-temperature sources such as radiant lamp heaters. The high intensity lamps in the prior art allow fast heating because of their fast thermal response, and rapid cooling because they can be turned off instantly. Compared to heating in a tube furnace, the thermal budget required for radiant lamp processes is reduced. However, due to temperature uniformity requirements, rapid thermal processing is typically limited to single-wafer processing. An approach to improve temperature uniformity consists in using multi-zone lamps and/or a wafer rotating mechanism. However, these systems are complex and increase costs and maintenance requirements. In addition, many lamps use a linear filament, which makes them ineffective at providing uniform heat to a round wafer. Lamp systems also tend to degrade with time and result in poor process repeatability.

U.S. Pat. No. 6,497,734 discloses another approach to fast heating via the use of resistive plate heaters. U.S. Pat. No. 6,765,178 discloses the use of system comprising a heat reflector and a supplemental resistive heater, which conforms to the heating chamber and surrounds the cassette carrying the wafer substrates. Resistive heaters provide a stable and repeatable heat-source. However, most resistive heaters tend to have a large thermal mass, which makes them unsuitable for fast thermal cycling. Faster-response resistive heaters can be made of sintered ceramics, but sintered ceramics are susceptible to thermal shock and tend to break when undergoing high temperature gradients.

The invention relates to an improved wafer handling assembly for providing a fast, stable, repeatable, energy-efficient, controlled and uniform thermal cycling for processing of one or multiple wafers.

### SUMMARY OF THE INVENTION

A wafer processing assembly for treating at least one semiconductor wafer substrate, the assembly comprises a cassette having at least a heating plate coupled to a vertically moveable shaft, wherein the heating plate comprises a substrate body with a heating surface configured in a pattern for an electrical flow path defining at least one zone of an electrical heating circuit, coated with a dielectric insulating coating layer comprised of at least one of a nitride, carbide, carbonitride or oxynitride of elements selected from a group consisting of B, Al, Si, Ga, refractory hard metals, transition metals, and rare earth metals, or complexes and/or combinations thereof, and wherein the wafer substrates are heated to a temperature of up to 800° C. at a rate of at least 10° C. per second. In one embodiment of the invention, the heating rate is in the range of 20° to 50° C. per second.

In one embodiment of the invention, the wafer processing assembly is for treating multiple semiconductor wafer substrates, wherein the assembly comprises a cassette having multiple heating plates.

The invention further relates to a method for treating at least a semiconductor wafer substrate in which the processing cycle comprises conduction heating for heating the wafer substrate to the desired processing temperature for a short period of time, then followed by radiation heating for the remaining processing cycle, then optionally followed by convective cooling to bring the wafer to desired handling temperature.

### BRIEF DESCRIPTION OF THE DRAWINGS

FIG. 1 is a cross section view of an embodiment of the wafer-handling chamber of the invention designed to handle multiple wafers.

FIG. 2 is a cross section view of a portion of the wafer handling chamber of the invention.

FIG. 3 is a diagram illustrating the equipment employed in a test conducted for Example 1.

FIG. 4 is a graph illustrating the steps of one embodiment of the method of the invention, for rapid heating and cooling of semiconductor wafers.

### DESCRIPTION OF THE INVENTION

As used herein, approximating language may be applied to modify any quantitative representation that may vary without resulting in a change in the basic function to which it is related. Accordingly, a value modified by a term or terms, such as “about” and “substantially,” may not to be limited to the precise value specified, in some cases.

“Wafer substrates” or “substrates” as used herein are in the plural form, but the terms are used to indicate one or multiple substrates can be used, and that “wafer” may be used interchangeably with “substrate.” Likewise, “heating plates,” “shelves,” “reflecting elements” or “reflectors” may be used the plural form, but the terms are used to indicate that one or multiple items may be used.

As used herein, the term “heating plates” may be used interchangeably with “heater” or “heating element” and that the term may be in the singular or plural form, indicating one or multiple items may be present.

The wafer-handling chamber assembly of the invention may be used in a system known as a cluster tool in the semiconductor industry. Besides substrate heating, the assembly may be used for other functions including annealing, deposition and/or etching.

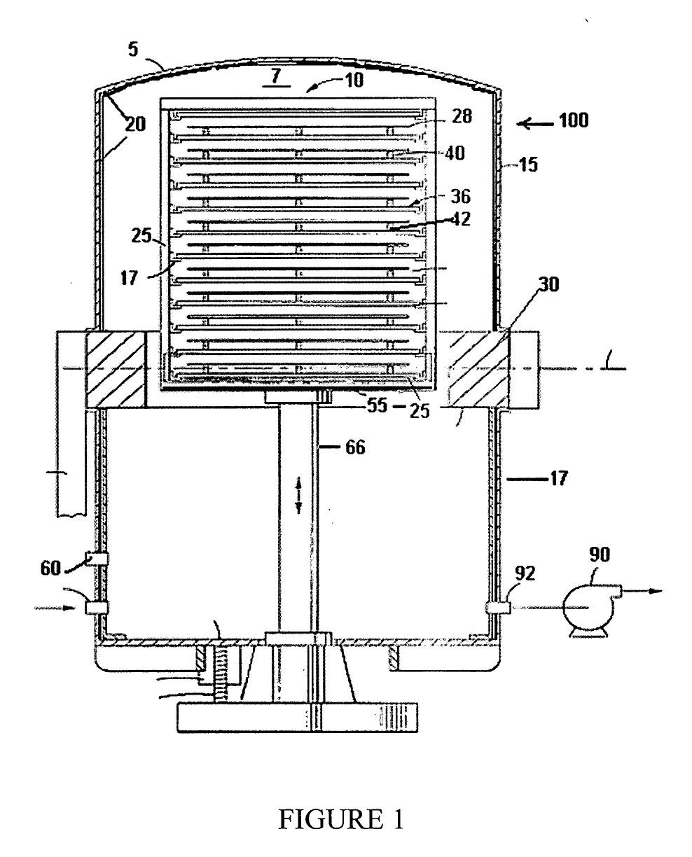

In one embodiment as illustrated in FIG. 1, a chamber 100 comprises an upper section 15 and a lower section 17. The upper and lower sections are sealably connected via a connecting body 30 comprising a loading window (not shown). The connections are made using materials such as gaskets, putty materials, or adhesives, etc. that are process resistant and contaminant-free. In another embodiment, the connections may be made by mechanical means such as welding, bolts, clamps, or other types of fasteners.

The assembly further comprises a cassette 10 moveably disposed within a cavity body 7 of the upper section 15. As used here in, a cassette or a cassette holder refers to an assembly having at least a frame to support one or a stack of multiple shelves, plates, and the like. Because the cavity 7 is used to hold one or multiple wafer substrates with the cassette 10, external atmospheric pressure on the chamber 100 under vacuum can be considerable. Therefore in one embodiment, the cavity 7 is of a semi-round shape as illustrated in FIG. 1. In another embodiment, the cavity may be of a round, square, or any shape to accommodate the substrates being processed, as long as it has sufficient integrity to withstand the external atmospheric pressures.

The cassette 10 in one embodiment is seated on a platform 55 coupled to a vertical motion shaft 66. The shaft and platform are comprised of process resistant materials such as aluminium, steel, tungsten, tantalum, molybdenum, and the like, adapted to withstand process temperatures and is generally free of contaminates such as copper.

The wafer substrates are located individually and unclamped on the separate shelves 36 of the cassette, which shelves are supported by a frame 25. Each substrate-heating shelf 36 comprises a heating plate 40 connected by brackets 17 to the frame 25. The brackets 17 connect the edges of the heating plates 40 to the frame 25 and may be attached to both the frame 25 and the heating plates 40 using adhesives such as pressure sensitive adhesives, ceramic bonding, glue, and the like, or fasteners such as screws, bolts, clips, and the like that are process resistant and are free of contaminates such as copper. The frame 25 and brackets 17 are comprised of process resistant materials such as ceramics, aluminium, steel, nickel, and the like that are process resistant and are generally free of contaminates such as copper. The frame 17 and brackets 25 may be separate items, or they can be integral to form support members for the heated substrate supports.

In one embodiment, the heating plates 40 are conformal to and slightly larger than the substrates 28 to maximize heating efficiency by applying a majority of the heat to the substrate. In another embodiment, the plates 40 may be of any shape adapted to provide desired substrate heating.

The substrate-heating shelves 36 are spaced vertically apart and parallel within the cassette 10 to define a plurality of substrate-heating spaces. Each heating plate 40 is adapted to heat at least one substrate 28. The wafer substrate is supported on a support structure 42 in the form of plurality of support pins. In one embodiment (not shown), the support structure 42 to hold the substrate 28 is in the form of an edge ring, or a support ring having sawtooth-shaped protrusions for supporting the substrate. The support structure is coupled with the vertically moveable shaft, allowing the lift pins/edge ring to be raised and lowered to support the back side of the substrate 28, e.g., to bring the substrate 28 to be in contact with the heating plate 40 for heating, or to move the substrate 28 away from the plate as the target temperature is reached.

As used herein, the term “coupled” refers to both direct or indirect connection, i.e., via an intermediate part such as brackets, connecting bars, etc., connecting the support structure or the heating plates to the shaft.

The heating shelves 36 above and below each substrate 28 establish the upper and lower boundary of the substrate-heating space such that the top and bottom sides of the substrate 28 are exposed to heat.

In one embodiment, the upper and lower boundaries are equidistant from the substrate 28 in order to ensure uniform heating of both sides of the substrate 28. In another embodiment, the spacing and substrate position may be adjusted to accommodate different heating requirements for different processes such as annealing, hydrogen removal, and the like. The spacing between the upper and lower shelves may be adjusted to increase or decrease the rate of heating, and the amount of heat applied to each substrate side. For example, the spacing between the upper and lower boundary of the heating space can be spaced more narrowly to increase the energy transfer from the heating plates 40 to thereby increase the temperature and rate of heating, or spaced further apart to reduce the incident energy transfer, thereby lowering the substrate temperature and slowing the heating of the substrate 28.

In another embodiment, the substrate 28 may be positioned closer to either the upper or the lower boundary to provide differing amounts of heating to either side of the substrate 28. In one aspect, to increase production efficiency, the spacing between the upper and lower boundary of the heating space may be adjusted to heat the substrate 28 at a desired rate and temperature while allowing the cassette 10 to hold as many substrate-heating shelves 40 as possible. In one aspect, the spacing between the upper and lower boundary is about 30 mm. In another embodiment, the spacing between the upper and lower boundary is about 60 mm.

Substrates with layers of different materials already built on their upper surface may have a non-uniform emissivity profile, which may result in a non-uniform temperature profile on this surface when heated directly from above. In one embodiment of the invention, a heat-reflecting element (not shown) is inserted at the bottom of each heating plate 40. The heat-reflecting element helps prevent or reduces the radiation of heat to the upper surface of the substrate 28. Furthermore, the heat-reflecting element improves the thermal efficiency of the heating plate by providing thermal insulation to the substrate 28 and the heating plate 40.

In one embodiment, the heat-reflecting element is a reflector having mirror-finished surface. In another embodiment, the heat-reflecting element is a film or sheet which covers the whole bottom face of the heating plate, made of a material that is process-resistant and generally free of contaminates such as copper. In a third embodiment, the heat-reflecting element is a surface plated with aluminium, nickel, gold, or other metal surfaces adapted to reflect heat.

For simultaneous fast thermal processing of multiple wafer substrates 28 and in order to achieve uniform heating of the wafer substrate 28, the present invention utilizes the heating plates 40 in a manner to provide both radiation and conduction heating, avoiding the thermal shock problems of sintered ceramic heating plates in the prior art. In the invention, the fast and uniform thermal processing is done via low-thermal mass ceramic heaters that can heat up the wafers using both conduction and radiation.

In one embodiment, the heater or heating plate 40 comprises a substrate body with a heating surface configured in a pattern for an electrical flow path defining at least one zone of an electrical heating circuit, and with a dielectric insulating coating layer encapsulating a patterned body.

In one embodiment, the substrate body of the heating plate 40 comprises graphite. In another embodiment, the substrate body comprises a material selected from one of quartz, boron nitride, sintered aluminum nitride, sintered silicon nitride, sintered body of boron nitride and aluminum nitride, and a refractory metal selected from the group of molybdenum, tungsten, tantalum, rhenium, and niobium. The coating layer of the heating plate 40 is comprised of at least one of a nitride, carbide, carbonitride or oxynitride of elements selected from a group consisting of B, Al, Si, Ga, refractory hard metals, transition metals, and rare earth metals, or complexes and/or combinations thereof.

In one embodiment, the heating element comprises a graphite body configured in a pattern for an electrical flow path, and at least a coating layer encapsulating the patterned graphite body, the coating layer comprising at least one of a nitride, carbide, carbonitride or oxynitride of elements selected from a group consisting of B, Al, Si, Ga, refractory hard metals, transition metals, and rare earth metals, or complexes.

In one example of a heating element as described in U.S. Pat. No. 5,343,022, the heating element comprises a pyrolytic boron nitride (pBN) plate as the substrate having a patterned pyrolytic graphite layer disposed thereon forming a heating element, and at least a coating layer encapsulating the patterned plate.

In another example of a heating element as described in US Patent Publication US20040074899A1, the heating element comprises a graphite body configured in a pattern for an electrical flow path for a resistive heater, encapsulated in at least a coating layer comprising one of a nitride, carbide, carbonitride or oxynitride compound or mixtures thereof.

In yet another example of a heating element as disclosed in US Patent Publication No. US20040173161A1, the heating element comprises a graphite substrate, a first coating containing at least one of a nitride, carbide, carbonitride or oxynitride compound, a second coating layer of graphite patterned forming an electrical flow path for a resistive heater, and a surface coating layer on the patterned substrate, the surface coating layer also containing at least one of a nitride, carbide, carbonitride or oxynitride compound.

In the embodiments of the invention, the surface of the heating element contacting the wafer while in conduction mode comprises a dielectric material. In one embodiment, the patterned resistance heating element is fully encapsulated by a dielectric coating. In other embodiments, the patterned resistance heating element may be exposed. In an example, the patterned resistance heating element is exposed but disposed on the bottom of a substrate, such that the wafer rests on the top of the dielectric substrate. In another example, the patterned resistance heating element exposed is on the top surface of the heating element such that the dielectric layer delimiting the patterned resistance heating element extends to a greater height than, but not over the patterned resistance heating element. In this case, the wafer substrate rests on the dielectric layer while the patterned resistance heating element is exposed below but does not contact the wafer.

Heaters, resistance heating elements, or heating plates that can be used in the assembly of invention are commercially available from General Electric Company of Strongsville, Ohio, as BORALECTRIC™ heaters, having a ramp rate of >5° C. per second. In one embodiment, the heaters have a ramp rate of >10° C., in another embodiment, a ramp rate of >30° C. per second. Other heaters with excellent resistance to thermal shock under extreme conditions and fast thermal response rates, e.g., with heating rates >5° C. per second, can also be used.

In one embodiment of the invention, the assembly further comprises a heat reflector 20 disposed within cavity 7. The heat reflector is installed inside the surface of the upper body 5 of the upper section 15, forming a reflective surface within the cavity 7. The heat reflector 20 is adapted to minimize heat losses through the body 5 by providing radiant heat insulation between the cavity 7 and its inner surface. The heat reflector 20 reflects radiated heat within the cavity 7 away from the inner surface and toward the center of the cavity 7. In one embodiment, the heat reflector 20 comprises a single layer. In another embodiment, the heat reflector 20 may comprise multiple layers, or several pieces combined to form a unified body.

In one embodiment, the heat reflector 20 comprises a heat conductor material such as aluminium, nickel, steel, and the like that are process resistant and generally free of contaminates such as copper. In another embodiment, the heat reflector 20 comprises an inner heat reflective surface plated with aluminium, nickel, gold, tungsten, tantalum, molybdenum or other surfaces adapted to reflect heat and that are process resistant and generally free of contaminates such as copper.

In one embodiment with additional insulation being desired between the cavity 7 and its inner surface, the heat reflector 20 further comprises insulators such as metal plated ceramics, glass, and the like that are process resistant and generally free of contaminates such as copper. The heat reflector 20 may be attached to the inner surface of the cavity 7 using several methods such as bonding to the inner surface 311 using pressure sensitive adhesives, ceramic bonding, glue, and the like, or by fasteners such as screws, bolts, clips, and the like that are process resistant and generally free of contaminates such as copper. Additionally, the heat reflector 20 can be deposited on the inner surface using techniques such as electroplating, sputtering, anodizing, and the like. In one embodiment (not shown), the heat reflector 20 is spaced from the inner surface of the cavity 7 using insulated fasteners such as insulated screws, bolts, clips, and the like, forming a gap there between the inner surface and the heat reflector 20.

Subsequent to the fast heating provided by the heating plates 40, the convective heat transfer is promoted by gas cross-flow for cooling down the wafers. In the present invention, the gas cross-flow is provided by at least a gas inlet 60 extending into the cavity for connecting the heating chamber 100 to a process gas supply for delivery of processing gases there through.

Pressure controllers (not shown) control the gas flows that may be introduced to the assembly.

The assembly of the invention allows for both heating and cooling processes to take place in the assembly. In one embodiment, the assembly further comprises a plurality of gas jets (not shown) mounted in the assembly. In another embodiment, the assembly is further bounded with an outside vessel having a water-cooled sidewall, a water-cooled bottom wall, and a forced-air-cooled top wall.

In one aspect of the invention, the wafers enter the processing chamber at a low temperature, e.g., less than 100° C., and leave it cold, i.e., also less than 100° C., thus suppressing the need for additional cooling steps outside the assembly. In another embodiment, the wafers leave the processing assembly at a temperature below 50° C.

In one aspect, a water trap with butterfly valve (not shown) and pump 90 is coupled to the cavity 7 through a vacuum port 92, to maintain a vacuum within the cavity by extracting water vapor and other contaminants from the assembly during vacuum pumping. Devices for pressure control, temperature control, and positioning of the substrate cassette, typically employed for a wafer-processing chamber are also used in conjunction with the assembly of the invention, although not shown in the Figure. In one embodiment, a point-of-use (POU) pump may be employed to pump down the assembly before the vacuum valve is open. The chamber assembly may also include a vacuum gauge with a range of ambient pressure to high vacuum, and a process manometer for controlling pressure.

A temperature controller controls the temperature of the wafer-processing chamber. The heater plates 40 of the cassette 10 are powered by a single power input or multiple individual power inputs to the heaters. This allows for a closed loop control based on the input from a single thermocouple or individual thermocouples. A thermocouple channel is provided for each heater plate. The channels are monitored and displayed at a control panel.

In one embodiment of the invention, each heating plate or heating element may further comprise cooling lines (not shown) to allow quick cool-down cycle time for timely maintenance. In one embodiment, gas is used in the cooling lines.

In one embodiment, a provision is made for a Residual Gas Analysis (RGA) for photo-resist and other contaminant detection. The RGA functions as a real time safety monitor and interlock to prohibit the station from processing the wafers that contain contaminants.

As used herein, the term heater is used interchangeably with heating plate or heater plate. In one embodiment of an operation processing wafers via the assembly of the invention, first the wafers 28 are loaded into the cassette, with each wafer being positioned in-between two heating plates or heaters 40. The support pins 42 are initially retracted so that the wafer 28 rests on the bottom heater.

The wafer handling assembly as illustrated in FIG. 1 is for handling multiple wafer substrates. In another embodiment (not illustrated), the heating assembly with heating plates, brackets, and the like are arranged in a slot-like vertical manner (instead of horizontal as illustrated in FIG. 1).

In another embodiment (not illustrated), the assembly is for a wafer-handling chamber to handle a single wafer with at least a heating plate resting on a support assembly. The heat plate comprises elements made of reflecting and/or insulating materials. In one embodiment, the assembly comprises a section with a loading window. In one embodiment, the heat-reflecting element has a reflective surface plated with a material that is process resistant and generally free of contaminants. Examples include aluminum, nickel, gold, or other surface adapted to reflect heat. In one embodiment, the support assembly is connected to the bottom wall of the chamber, or is attached to the sidewalls of the chamber by mechanical means such as welding, bolts, clamps, brackets or other types of fasteners. The wafer substrate is located unclamped on the heating plate. The wafer handling assembly may further comprise a second heating plate or a reflecting element located above the wafer substrate.

In another embodiment, instead of or in addition to shelves, the heating elements supporting the wafers may comprise rings, plates, arms, and the like. In one embodiment, these elements are connected to one or several lifting mechanisms providing vertical motion to the supporting elements and the wafer.

In one embodiment, the heaters and their additional components such as reflectors, baffles, connecting elements, etc., are fixed with respect to the chamber. In another embodiment, the supporting elements are fixed with respect to the chamber while the heaters and their components are moved vertically. The heater assembly includes a moving mechanism that controls the supporting elements of the heater structure. This moving mechanism, which is fixed relative to the chamber, provides vertical motion to the heaters. In one embodiment, the moving mechanism is designed such that the heaters slightly lift the wafers from their supporting elements, thus ensuring full contact, when the moving mechanism is at its maximum upward position. In yet another embodiment, the heater assembly is designed to allow moving downwards when the wafer temperature approaches the design temperature, for switching the heating mode from conduction to radiation.

In operations, the heaters may be preheated to a temperature of about 200-400° C., or are already at a temperature on the order of 200-400° C. from the prior cycle. In one embodiment, no power or very little power is supplied. As the cassette 10 shifts to the processing position, power is given to the heaters 40, which heat the wafers 28 by conduction (from the heater located under each wafer) and radiation (from the heater located above each wafer). Conduction is much more efficient than radiation for heating at these temperatures, therefore, the wafer is set to rest on the bottom heater. The use of the ceramic heaters 40 with a very fast thermal response, results in very fast heating of the wafers with heating rates that are in excess of 10° C./sec in one embodiment, 20° C./sec in another embodiment, and in excess of 50° C./sec in a third embodiment, to bring the wafers 28 to a process temperature on the order of 300-1000° C. In one embodiment of the invention, the wafers are heated from room temperature to 500° C. at a rate of at least 15° C. per second (“ramp rate”).

As a wafer 28 approaches the process temperature, the support structure 42, e.g., lift pins lift it from the heater 40 to a position in-between the heaters (from 5 to 20 mm spacing between wafer 28 and each of the upper/lower heater 40). In one embodiment, this happens when the wafer temperature is within 200° C. of the target wafer temperature. In another embodiment, this is within 100° C. In a third embodiment, within 50° C. of the target wafer temperature. This will help ensure uniform heating of the wafer.

In one embodiment, the power input to the heaters can also be adjusted as a function of time to prevent the wafer temperature from overshooting the process temperature. The heater power input is generally higher during the ramping phase and then decreased after a certain time to avoid overshooting, but any power-time function that achieves the requirement of no overshooting can be used. Additionally, with the lifting of the wafer 28, radiation heating provides more uniform heating compared to conduction because of imperfect thermal contact between wafer and heater. Contact enables fast conduction heating, but thermal uniformity on the wafer surface may suffer.

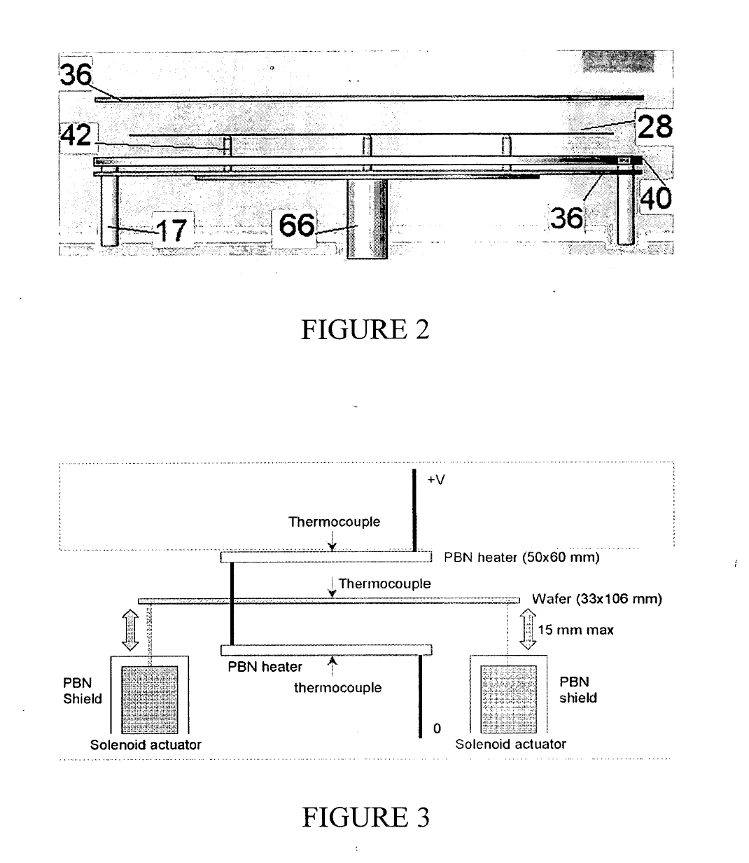

After conduction heating via direct contact with the heating plate, the temperature of the wafer substrate 28 can be controlled via radiation heating. In one embodiment as illustrated in FIG. 2, the cassette 10 holding the heating plates 40 is connected to a shaft 66, thus allowing for vertical motion of the cassette and the heating plates connected thereto. In another embodiment, the heating plates may be coupled directly to the shaft 66 or indirectly to the shaft 66 via support brackets to a cassette. As the heater temperature approaches the target process temperature, the heating can be switched from conduction to radiation heating.

In one embodiment, the heating plates may be lowered via the vertically moveable shaft to create a non-contacting gap in the range of 0.5-10 mm with the wafer to avoid overshooting the target temperature. In one embodiment, the plates are lowered to obtain a gap of 2 mm. In another embodiment, a non-contacting gap of 5 mm is created.

In another embodiment, a non-contacting gap in the range of 0.5-10 mm may be created by raising the wafer 28 away from the heating plate 40 through the movement of the lift pins 42, or by lowering the heating plate 40 away from the wafer 28 through the movement of the cassette 10 when the wafer temperature approaches the target temperature. The desired time-temperature profile for the wafer, including high ramp with no overshoot of target temperature, is a function of the process variables, including but limited to initial wafer temperature, target wafer temperature, initial heater temperature, heater power as a function of time, non-contacting gap creation time, and non-contact gap width.

In one example in which the initial wafer and heater temperatures are at room temperature, e.g., 25° C. and the target temperature is 350° C., a wafer ramp rate of 15° C./s is achieved to the 350° C. target temperature with an input initial power density of 30 W/cm² in the two heaters located below and above the wafer, followed by a reduction of power density to 1 W/cm² after 13 seconds and wafer lift-off after 19 seconds. The wafer temperature is held constant at 350° C. within 5° C. for 100 seconds before cool down.

As illustrated above, the assembly of the invention combines the advantages of conduction for fast heating and the benefits of radiation for uniformity and temperature control. The wafer temperature is rapidly ramped to and controlled at the process temperature(s) to closely follow the prescribed time-temperature recipe of wafer processing, taking advantage of the heater plates 40.

The wafers are then cooled down by turning off power on the heaters 40 and injecting a gas cross-flow on each side of the wafers 28 now supported by pins 42. In this configuration, cooling gas is allowed to flow across both sides of a wafer 28, which is more efficient for cooling than if the wafer rests on the heater. The wafers 28 are allowed to cool down to a low temperature (less than 100° C.), while the heaters 40 are cooled down to their initial temperature (200-400° C.). The use of the heating plates or heaters of the invention with inherently low thermal mass enables more rapid cool down, and allows longer operation period of the chamber assembly since these heaters tend not to suffer from thermal shock, as do sintered ceramic heaters.

In thermal simulations, it is demonstrated that ceramic heaters comprising a dielectric coating are able to provide extremely high heating rates to a silicon wafer on the order of 20° C./s and in some embodiments of at least 50° C./s to drastically shorten the time necessary to process the wafers. Additionally, thermal models show that conduction is much more efficient method for heating a wafer than radiation when the heater starts below 400° C. Furthermore, the power requirements for rapidly heating a wafer using a heater starting at low temperature are too high for practical purposes, even using the graphite heaters of the invention. Therefore, in one embodiment of the process using the assembly of the invention, the process is started with heaters that have been heated up to at least 200° C., and in one embodiment, the heaters are preheated to a temperature of 200° C.-400° C.

In other finite element thermal models, the results employing single-heater configurations of the prior art are used to validate the configuration of the wafer-processing chamber of the invention with wafers positioned in-between two heating plates of the invention. It is shown that the power required for rapid heating of a wafer suspended in-between the two heaters (radiation heating) is still too high for practical applications, even with the heaters starting hot. Thermal models are also used to simulate processing conditions when the wafer is positioned to rest on a bottom heater, where heating occurs from the bottom heater through conduction and from the top heater through radiation. We find that radiation heating from the top heater contributes a small amount to the overall heating of the wafer, with the majority of heat coming from conduction through the bottom heater. Furthermore, the model also shows that with the assembly of the invention, the wafer cools down rapidly to a low temperature of less than 100° C. using gas cross flow when the wafer is lifted off the bottom heater. This allows the gas to flow on both sides of the wafer for efficient heat transfer.

In other thermal models testing a mixed conduction/radiation case, wherein the wafer is lifted off the heating plate during the heating process for combined fast heating through conduction and uniformity through radiation, it is demonstrated that fast cooling of the wafer can also be achieved for the wafer to be cooled down to less than 200° C.-400° C., which is the starting temperature of the pre-heated heating plates in one embodiment of a method to use the wafer processing assembly of the invention.

The invention is further illustrated by the following non-limiting examples.

### EXAMPLE 1

A series of tests are conducted on a silicon wafer positioned in-between two heaters from General Electric Company sold under the trade name BORAELETRIC. A sketch of the set up is as illustrated in FIG. 3. The wafer is supported by three solenoid actuators, so that the wafer rested on the bottom heater when the solenoid arms are fully retracted. Simultaneously powering the solenoid actuators extends the solenoid arms, such that the wafer can be lifted from the bottom heater and positioned halfway in-between the two heaters. Fast-response wire thermocouples are used to measure temperature on the wafer surface at various points. The power input to the heaters is varied as a function of time. Time at which the solenoids are powered (wafer lift-off time) can also be adjusted.

For each test, the wafer is first heated at high power in a conduction mode for a period of time ranging from 5 to 30 seconds (“transition time”) to obtain the desired process temperature. At the transition time, the wafer is then lifted from the heater to promote thermal uniformity. Once the wafer is at the desired process temperature, the heater power is decreased to maintain the desired process temperature. The wafer is then heated by radiation at the desired process temperature for some hold time for e.g. annealing, or may be immediately cooled. In the radiation heating mode, the wafer temperature remains rather constant with a variation of ±10% of the desired process temperature. Two main parameters are varied in the tests, the conduction heating time (at high power) and the wafer lift-off time. At the end of the hold time, the heater power is turned off for cool down. In some of the tests, the cool-down is via convective cooling with gas cross flow. Examples of cooling gases include Ar, He, N₂, and the like, for a cool down/drop of at least 200° C. in 1 minute or less.

The results of the test show that a fast wafer ramp rate of room temperature to 300° C. or more can be obtained in a period of 30 seconds or less (ranging from 5 to 30 seconds depending on the power supply) with the heater having a ramp rate of more than 5° C. per sec, and up to 50° C. per sec. Furthermore, there is no problem with overshooting the design temperature by suitably adjusting the wafer lift-off time. Further, with a suitable combination of time-dependent heater power input and wafer lift-off time, a specified wafer temperature profile typical of fast thermal cycling processes can be obtained, i.e., at least one fast heating period, one constant temperature portion of a sufficient time or no time, and one fast cooling period.

### EXAMPLE 2

A series of tests are conducted with a set-up including a wafer supported by three solenoid actuators. The wafer is located above a GE Boralectric heater such that the wafer rests on the heater when the solenoid arms are fully retracted. When the solenoid actuators are powered, they extend the solenoid arms such that the wafer is lifted above the heater.

### EXAMPLE 3

A heat reflector is used in conjunction with the set up of Example 1. The results of the test show that the presence of a heat reflector effectively increases the heating rate and reduces the thermal budget of the process.

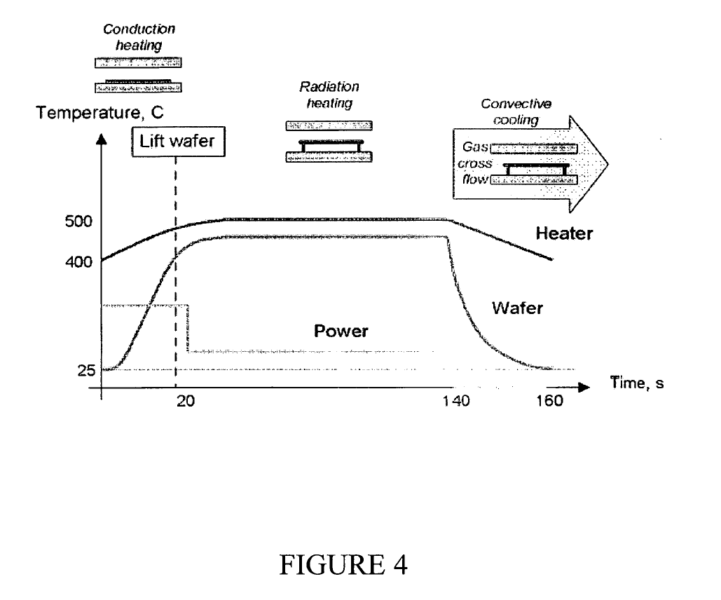

Representative data from Examples 1 and 2 tests are illustrated in FIG. 4. As shown, a suitable combination of time-dependent heater power input and wafer lift-off time allows a specified wafer temperature profile of fast thermal cycling processes, i.e. consisting of at least one fast heating period (conduction mode), one constant temperature portion (radiation mode), and an optional fast cooling period. The graph illustrates a suitable time-dependent combination of two heating modes, a conduction heating mode first for rapid heating (wafer heating rate >10° C./s), followed by a radiation heating step for maintaining a constant temperature profile. In some of the tests, the wafer heating rate is >20° C./s. Additionally, a suitable time-dependent combination of both heating modes is very effective to prevent overshooting the design temperature at the end of a fast heating period, which is typically difficult to avoid with conduction-based systems due to the inherently high thermal inertia of these systems.

### EXAMPLE 4

A series of tests are conducted with a system processing a 300 mm substrate. The system comprises a 340 mm ceramic diameter mounted in a test chamber, a lift pin base connected to a shaft allowing vertical motion, and ceramic lift pins able to protrude through the heater inside lift pin holes. The substrate tested includes 9 embedded thermocouples for measuring its temperature uniformity. The series of tests in this Experiment demonstrate that at a 300 mm scale, fast ramp is achievable with the system of the invention (with no overshoot of target temperature). Furthermore, these tests show that excellent thermal uniformity is obtainable on the substrate once it has been lifted from the heater (typically within 1-2%). In one embodiment, the difference between the maximum temperature and the minimum temperature measured on the wafer is less than 10° C. at an average wafer temperature of 560° C.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

All citations referred herein: are expressly incorporated herein by reference.

1. A device for use in a semiconductor processing chamber, which device comprising:
a heater and a holder assembly having at least one resistance heating element for heating at least an object of varying sizes having an initial temperature to a target temperature at least 50° C. higher than the initial temperature,
at least a vertically moveable shaft for supporting the assembly,
wherein the heating element is patterned in a plurality of circuits defining at least one zone for independent controlled heating of said at least one object of varying sizes on the platform, at least a portion of the surface of the heating element is coated with a dielectric insulating layer comprising at least one of a nitride, carbide, carbonitride or oxynitride of elements selected from a group consisting of B, Al, Si, Ga, refractory hard metals, transition metals, and rare earth metals, or complexes and/or combinations thereof,
the heating element has a ramp rate of at least 1° C. per second for heating the object from the initial temperature to the target temperature.

2. The device of claim 1, wherein the vertically moveable shaft is coupled to the heating element for lowering or raising the heating element to create a non-contact gap of about 0.5 mm to 10 mm between the heating element and the object.

3. The device of claim 1, further comprising a support structure for supporting the object on the heating element, and wherein the vertically moveable shaft is coupled to the support structure for lowering or raising the support structure to create a non-contact gap of about 0.5 mm to 10 mm between the heating element and the object.

4. The device of claim 1, wherein the dielectric insulating layer comprises least one of aluminum nitride and pyrolytic boron nitride.

5. The device of claim 1, for heating said object from room temperature to a temperature of 350° C. or greater at a rate of at least 10° C. per second, and wherein said object is a wafer substrate.

6. The device of claim 5, for heating said substrate from room temperature to a temperature of 350° C. or greater at a rate of at least 20° C. per second.

7. The device of claim 1, further comprising the heat reflector disposed below the heating element.

8. The device of claim 1, wherein the heat reflector comprises at least one of the group consisting of aluminum, nickel, steel, tungsten, tantalum, molybdenum and combinations thereof.

9. A wafer-processing chamber, comprising the device of claim 1.

10. The wafer processing chamber of claim 9, further comprising a pump coupled to the assembly to maintain the vacuum therein.

11. The wafer processing chamber of claim 10, further comprising a heat reflector disposed within said chamber, and wherein the heat reflector comprises a heat reflective surface.

12. The wafer processing chamber of claim 11, wherein said heat reflective surface comprises at least a material selected from the group consisting of glass, ceramics, and combinations thereof.

13. The wafer processing chamber of claim 11, wherein said heat reflective surface comprises at least a material selected from the group consisting of aluminium, nickel, steel, tungsten, tantalum, molybdenum and combinations thereof.

14. A wafer processing device for heating a plurality of semiconductor wafer substrates from an initial temperature to a target processing temperature, said chamber comprising:
a plurality of resistance heating plates movably disposed within an assembly to support at least a wafer substrate thereon,
each heating element is patterned in a plurality of circuits defining at least one zone for independent controlled heating of said at least one object of varying sizes on the platform,
each heating plate is coated with a dielectric insulating layer comprising at least one of a nitride, carbide, carbonitride or oxynitride of elements selected from a group consisting of B, Al, Si, Ga, refractory hard metals, transition metals, and rare earth metals, or complexes and/or combinations thereof,
each heating plate is individually controlled to raise the temperature of the wafer substrate at a rate of at least 5° C. per second.

15. The wafer processing device of claim 14, wherein said plurality of resistance heating plates are moved up or down creating a non-contact gap of at least 0.5 mm.

16. The wafer processing device of claim 14, wherein the substrates are movably supported on the resistance heating plates by a plurality of support pins.

17. The method of claim 14, further comprising the step of:
rapidly cooling said wafer substrate through the use of a cooling device; the cooling device comprises a cooling member at a temperature lower than the initial temperature of said wafer substrate.

18. The method of claim 14, wherein said wafer substrate is heated to at least 100° C. or greater within 25 seconds.

19. The method of claim 14, wherein said wafer substrate temperature is controlled within 15° C. from the target temperature.

20. A method for processing a wafer substrate, the method comprising:
positioning the wafer substrate on a resistance heating plate, the heating plate is patterned in a plurality of circuits defining at least one zone for independent controlled heating of said at least one object of varying sizes on the platform, the heating plate is coated with a dielectric insulating layer comprising at least one of a nitride, carbide, carbonitride or oxynitride of elements selected from a group consisting of B, Al, Si, Ga, refractory hard metals, transition metals, and rare earth metals, or complexes and/or combinations thereof,
increasing the heating plate temperature at a rate of at least 1° C. per second to heat the wafer substrate from an initial temperature to a target temperature by conduction heating,
creating a non-contacting gap between the wafer substrate and the heating plate; and
optionally, controlling a power input to the heating plate to maintain the wafer substrate temperature within 15% of the target temperature.

21. The method of claim 20, where the non-contacting gap is created by lifting the wafer substrate wafer away from the heating plate.

22. The method of claim 20, where the non-contacting gap is created by moving the heating plate away from the substrate wafer.

23. A method for heating at least a wafer substrate from room temperature to a temperature of 100° C. or greater at a rate of at least 10° C. per second using a heating assembly comprising a heater and a wafer holder assembly having at least one resistance heating element for placement of the wafer substrate, the method comprising:
rapidly heating said the wafer substrate to a predetermined temperature via conduction heating at a rate of at least 5° C. per second;
controlling the predetermined temperature within a variation range of 15% via radiation heating.

24. The method of claim 23, wherein
the conduction heating is done via the at least one resistance heating element patterned in a plurality of circuits defining at least one zone for independent controlled heating of said at least one object of varying sizes on the platform, the heating plate is coated with a dielectric insulating layer comprising at least one of a nitride, carbide, carbonitride or oxynitride of elements selected from a group consisting of B, Al, Si, Ga, refractory hard metals, transition metals, and rare earth metals, or complexes and/or combinations thereof,
the radiation heating is done by creating a non-contact gap between the wafer substrate and the heating plate.

25. The method of claim 24, wherein
the non-contacting gap is created by lifting the wafer substrate wafer away from the heating plate or by moving the heating plate away from the substrate wafer.
